(19) United States
(12) Patent Application Publication
(10) Pub. No.: US 2023/0334335 A1
(43) Pub. Date: Oct. 19, 2023

(54) SYSTEM AND METHOD FOR SOFTWARE PROGRAM GENERATION USING GENETIC PROGRAMMING

(71) Applicant: Perceiver AI LLC, Milford, CT (US)

(72) Inventor: Milton Hernandez, Ridgefield, CT (US)

(21) Appl. No.: 17/722,950

(22) Filed: Apr. 18, 2022

(51) Int. Cl. G06N 3/12; G06K 9/62

(52) U.S. Cl. CPC G06N 3/126; G06K 9/6277

(57) ABSTRACT

A method and system for generating programs, the method comprising generating a first population of candidate programs based on at least one of existing solution programs or knowledge data, testing the candidate programs for suitability based on a fitness function, calculating and assigning fitness scores to the candidate programs, determining whether a terminating condition has been satisfied based on fitness scores of the candidate programs, selecting one or more of the candidate programs based on fitness scores of the one or more of the candidate programs, applying at least one genetic operator to the selected candidate programs to create a second population of candidate programs, determining plateauing of program fitness progress based on at least the first population of candidate programs and the second population of candidate programs, producing an extinction of candidate programs, and generating a new breeding pool.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

### Field of the Invention

This application generally relates to artificial intelligence, and in particular, evolving programs for use in conjunction with a computer system by employing genetic programming.

### Description of the Related Art

Many artificial intelligence systems rely on neural networks. Neural networks comprise mathematical models that use machine learning algorithms inspired by the brain to process information. A neural network is trained or formed by providing inputs and corresponding outputs that are used by a learning algorithm to form nodes and associations between the nodes based on the provided inputs and outputs. Each association has a weight, which determines the strength of one node's influence on another. The neural network iteratively adjusts the weights to get the outputs closer to a desired result.

Neural networks have gained widespread adoption in solving optimization problems in many applications, such as in finance, engineering, transportation, medicine, and cyber security. A goal of solving an optimization problem is to find the best solution out of all possible solutions. An optimization problem often involves minimizing or maximizing an objective function representing the quality of a possible solution for a specific problem, subject to certain constraints. For example, companies usually seek solutions to maximize performance, such as profit and customer satisfaction, or minimize unwanted traits like material wastage and churn.

However, a disadvantage of neural networks is their “black box” nature. In particular, the manner in which the nodes and associations are formed are unintelligible to humans and cannot be easily explained or reasoned intuitively. As such, it is often the case that one is unable to ascertain how or why a neural network produced a certain result. Another disadvantage of neural networks is that they are limited solely to pattern matching and are susceptible to overfitting. Overfitting results from a neural network that learns too many details in a training data set along with any noise in the training data set.

Existing machine learning methods using neural networks make it difficult to incorporate existing relevant domain knowledge in solutions. Most problems in the world, particularly optimization problems, require more than just pattern recognition and matching to fully solve. Neural networks also have limits on learning that are constrained by a predefined architecture.

Genetic programming generally refers to a machine learning technique that evolves or breeds a population of unfit or random programs into computer program code suitable to solve targeted problems. An advantage of genetic programming systems over neural networks is that it is possible to explain how such systems make decisions. For example, program code produced by a genetic programming system can be expressed in a human-readable programming language.

A genetic programming system may be implemented by specifying a targeted problem to solve and applying operations comprising a set of genetic operators to parent programs from a population for creating or breeding child programs, analogous to naturally occurring genetic processes. The child programs are evaluated on the basis of a fitness function which determines how well a given program solves the targeted problem. A large universe (or “space”) of possible solutions may be searched through and given sufficient computational time, good candidate programs (i.e., those that perform well as measured by predetermined criteria) may be generated and identified. Evaluations of previously generated programs may facilitate construction of new programs to guide the search for additional or improved programs. Programs comprising better solutions to the targeted problem are given opportunities to reproduce until a program that is fit for solving the targeted problem is found.

Further description and details of genetic programming systems may be found in: “Genetic Programming: On the Programming of Computers by Means of Natural Selection,” 1992, John R. Koza; “Genetic Programming: A Paradigm for Genetically Breeding Populations of Computer Programs to Solve Problems,” Stanford University Computer Science Department technical report STAN-CS-90-1314, June 1990, John R. Koza; and U.S. Pat. No. 4,935,877, entitled “Non-Linear Genetic Algorithms for Solving Problems,” to Koza, John R., filed on May 20, 1988, which are hereby incorporated by reference in its entirety.

However, traditional methods of genetic programming offer no direct way to incorporate expert knowledge. Another common issue with genetic programming is that when used for the purpose of optimization, grammar-based expressions can be bloated and computationally demanding. Bloating may result in an excess of code growth without a corresponding improvement in solution fitness. Additionally, grammar-guided genetic programming gives no consideration to certain types of expressions or construct elements which leads to the creation of useless programs.

There is thus a need for artificial intelligence that can generate a solution to optimally and predictably solve a defined goal that is useable in the real world.

### SUMMARY OF THE INVENTION

The present invention provides a method and system comprising artificial intelligence computing systems configured to automatically generate programs using genetic programming. Genetic programming may comprise a machine learning technique used by an artificial intelligence computing system to perform genetic operations on an initial population of unfit or random programs to create additional populations of programs that are incrementally better suited to solve a targeted problem. The artificial intelligence computing system may eventually arrive at computer program code having a target suitability to solve the targeted problem.

According to one embodiment, the system comprises a program generation unit configured to generate solution programs for solving a targeted problem. The program generation unit comprises a population generation module that generates a first population of candidate programs based on at least one of existing solution programs or knowledge data, wherein the existing solution programs or knowledge data is associated with the targeted problem. The system further comprises a genome control unit configured to select one or more of the candidate programs from the first population and instruct the population generation module to apply at least one genetic operator to the selected candidate programs to create a second population of candidate programs. The system further comprises a success analyzer that determines whether or not a terminating condition has been satisfied based on fitness scores of the candidate programs from the first and second populations, and a ranking module that calculates and assigns fitness scores to the candidate programs from the first and second populations. The system further comprises a plateau controller configured to determine plateauing of program fitness progress based on at least the fitness scores of the candidate programs from the first and second populations, delete the second population of candidate programs based on the determined plateauing, and generate a third population of candidate programs.

The plateau controller may be further configured to determine plateauing of program fitness progress by calculating information gain of a best candidate program from the second population with respect to a fitness function. The plateau controller may calculate the information gain by comparing output and performance of candidate programs from the second population with output and performance of candidate programs from the first population. The plateau controller may be further configured to increase a bad generation counter if the information gain is less than a minimum information gain. The plateau controller may be further configured to delete the second population of candidate programs based on the bad generation counter exceeding a stagnation limit parameter. In one embodiment, the plateau controller may be further configured to load candidate programs from the first population, select given ones of the loaded candidate programs that have not been previously selected, and apply the at least one genetic operator to the selected given ones of the loaded candidate programs into the new breeding pool.

The genome control unit may further comprise a grammar logic comprising instructions defining structure and construct of programs generated by the population generation module. The grammar logic may be configured to specify programming structure and elements allowed for programs generated by the population generation module based on either a predefined or dynamically adjusted statistical probability. The grammar logic may include a grammar specifying an architecture for candidate programs based on weighted probabilities. The weighted probabilities may be assigned based on statistical analysis of program attributes or on the basis of trial and error. The grammar logic may be configured to specify a set of rules that is described by Backus-Naur Form grammar.

The genome control unit may further comprise a forced breeding controller configured to select best candidate programs from the first and second populations and create a reserve breeding pool with the selected best candidate programs. The forced breeding controller may be further configured to inject characteristics of the selected best candidate programs from the reserve breeding pool into a genome of programs and create a new population using the genome of programs.

According to one embodiment, the method comprises generating a first population of candidate programs based on at least one of existing solution programs or knowledge data, wherein the existing solution programs or knowledge data is associated with the targeted problem. The method further comprises calculating and assigning fitness scores to the candidate programs from the first population, determining whether or not a terminating condition has been satisfied based on the fitness scores, selecting one or more of the candidate programs from the first population based on the fitness scores, and applying at least one genetic operator to the selected candidate programs to create a second population of candidate programs. The method further comprises calculating and assigning fitness scores to the candidate programs from the second population, determining whether or not a terminating condition has been satisfied based on the fitness scores of the candidate programs from the first and second populations, determining plateauing of program fitness progress based on at least the fitness scores of the candidate programs from the first population and the second population, deleting the second population of candidate programs based on the determined plateauing, and generating a third population of candidate programs.

The method may further comprise determining plateauing of program fitness progress by calculating information gain of a best candidate program from the second population with respect to a fitness function. In one embodiment, the method further comprises loading candidate programs from the first population, selecting given ones of the loaded candidate programs that have not been previously selected for breeding, and inserting the selected given ones of the loaded candidate programs into the new breeding pool. The first and second populations of candidate programs may be generated based on a grammar specifying an architecture for candidate programs based on weighted probabilities. In another embodiment, the method may further comprise selecting best candidate programs from the first and second populations and creating a reserve breeding pool with the selected best candidate programs. In yet another embodiment, the method may further comprise injecting characteristics of the selected best candidate programs from the reserve breeding pool into a genome of programs and creating a new population using the genome of programs.

According to one embodiment, the method comprises generating a first population of candidate programs based on at least one of existing solution programs or knowledge data, wherein the existing solution programs or knowledge data is associated with the targeted problem. The method further comprises applying at least one genetic operator to given ones of the candidate programs from the first population to create a second population of candidate programs, calculating and assigning fitness scores to the candidate programs from the second population, and determining plateauing of program fitness progress by calculating information gain of a best candidate program from the second population with respect to a fitness function, wherein the information gain is based on a comparison of output and performance of candidate programs from the second population with output and performance of candidate programs from the first population. The method further comprises increasing a bad generation counter based on the information gain being less than a minimum information gain and deleting the second population of candidate programs based on the bad generation counter exceeding a stagnation limit parameter.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 illustrates an artificial intelligence computing system according to an embodiment of the present invention.

FIG. 2 illustrates a data flow diagram of an artificial intelligence computing system according to an embodiment of the present invention.

FIG. 3 illustrates a genome control unit according to an embodiment of the present invention.

FIG. 4 illustrates a grammar tree according to an embodiment of the present invention.

FIG. 5 illustrates a flowchart of a method for managing program population extinctions according to an embodiment of the present invention.

FIG. 6 illustrates a flowchart of a method for breeding candidate programs with desired characteristics according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

The present application discloses machine learning techniques for training artificial intelligence machines to create programs for solving optimization problems using genetic programming.

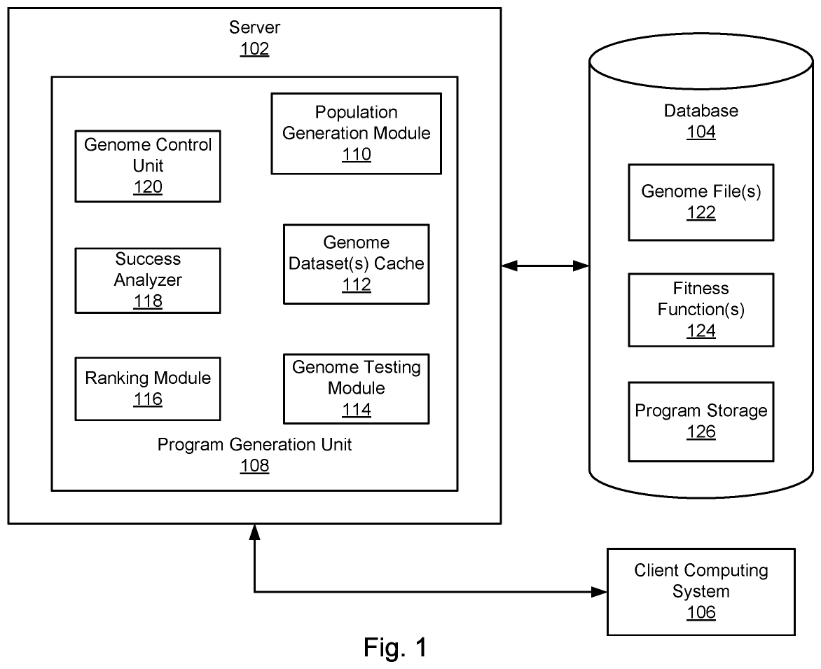

FIG. 1 presents an artificial intelligence computing system according to an embodiment of the present invention. The artificial intelligence computing system comprises a server 102, a database 104, and a client computing system 106. The server 102 may include one or more processor(s), a memory, a power supply, one or more of mass storage devices, wired or wireless network interfaces, input/output interfaces, and operating systems, such as Windows Server, Mac OS X, Unix, Linux, FreeBSD, or the like. The processor(s) may access modules, programs and/or instructions stored in memory and perform processing operations, including the methods described herein.

Client computing system 106 is communicatively coupled to server 102, e.g., via a network. The network may be any suitable type of network allowing transport of data communications across thereof. In one embodiment, the network may be the Internet, following known Internet protocols for data communication, or any other communication network, e.g., any local area network (LAN) or wide area network (WAN) connection, cellular network, wire-line type connections, wireless type connections, or any combination thereof. The client computing system 106 may comprise a computing device (e.g., desktop computers, terminals, laptops, personal digital assistants (PDA), cellular phones, smartphones, tablet computers, or any computing device having a central processing unit and memory unit).

Server 102 may comprise an artificial intelligence computing system including a program generation unit 108 configured to generate solution programs, such as ones able to solve optimization problems, using genetic programming. Optimization problems may be specified or provided to program generation unit 108 by client computing system 106. An optimization problem may be presented to program generation unit 108 as a fitness function. A fitness function may comprise training data including input data and corresponding expected output data. Fitness function(s) 124 may be stored to database 104.

Program generation unit 108 comprises population generation module 110, genome dataset(s) cache 112, genome testing module 114, ranking module 116, success analyzer 118, and genome control unit 120. Program generation unit 108 is configured to generate solution programs for solving a targeted problem. The population generation module 110 may be configured to generate candidate programs. Candidate programs are representative of programs that are potential solutions to the targeted problem.

The population generation module 110 may be initially seeded with programs based on genome file(s) 122 or program storage 126. The genome file(s) 122 may be provided by client computing system 106 and stored to database 104. Genome file(s) 122 may comprise sample programs and/or knowledge data that can be used to create an initial population of candidate programs. Program storage 126 may comprise a store of existing solution programs that are able to solve the targeted problem. Solution programs may be used to seed an initial population to accelerate evolution (e.g., improvement) of candidate program populations and/or to improve upon the existing solution programs.

Genome dataset(s) cache 112 may provide temporary storage of candidate program populations generated by population generation module 110. Genome testing module 114 may be configured to test candidate programs for suitability using the fitness function(s) 124. Ranking module 116 may rank each candidate program in a current population according to testing performed by genome testing module 114. Success analyzer 118 may determine whether a termination condition has been satisfied based on the fitness scores of candidate programs, such as a candidate program in the current population that adequately solves a targeted problem. If at least one candidate program is determined as a solution program that is sufficient to solve the targeted problem, the solution program may be stored to program storage 126.

If the termination criterion hasn't been satisfied, further creation and searching of solution programs are performed. Genome control unit 120 may be configured to manage genetic programming processes. Genome control unit 120 may be configured to select candidate programs from the current population as parents for creating a new generation of children candidate programs. Genome control unit 120 may receive or be configured with parameters, such as a set of parameters for a programming language syntax, minimum information gain, stagnation limit, selection threshold, maximum breeding, population sizes, a target fitness, and other factors that may be used for creating program populations, which are further described below.

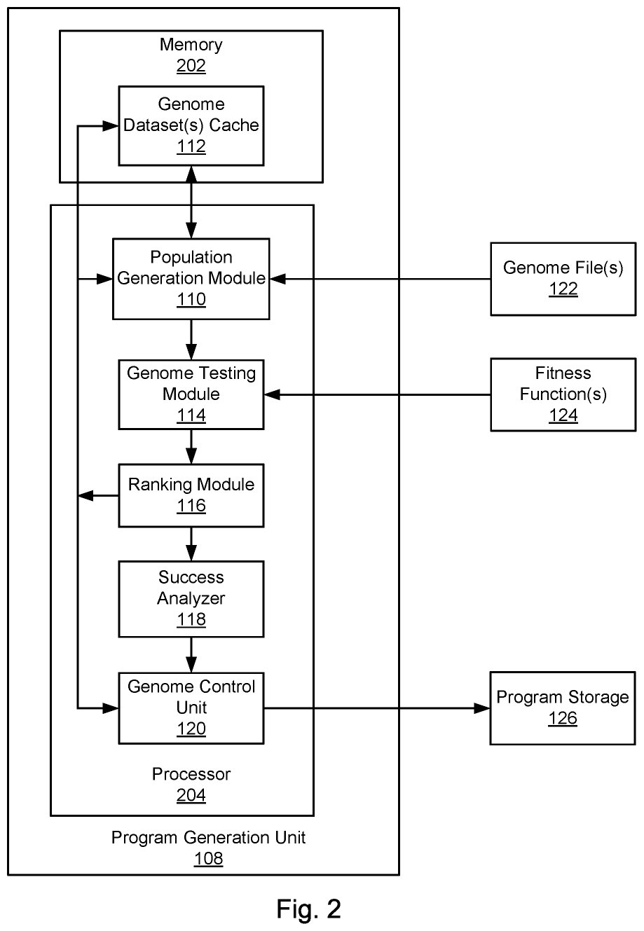

FIG. 2 presents a data flow diagram of an artificial intelligence computing system according to an embodiment of the present invention. Population generation module 110 may initialize a first generation population of candidate programs with randomly generated programs. According to another embodiment, population generation module 110 may initialize the first generation population of candidate programs using genome file(s) 122. Population generation module 110 may temporarily store the population of candidate programs to genome dataset(s) cache 112.

Genome testing module 114 may access the programs from genome dataset(s) cache 112 and execute each of the candidate programs to ascertain fitness based on one or more of fitness function(s) 124. Genome testing module 114 may apply one or more fitness function(s) 124 (e.g., provide input) to the candidate programs and gather output from the candidate programs.

Output and performance of the candidate programs may be evaluated by ranking module 116. Evaluation of the candidate programs may include determining fitness by measuring deviation or matching of actual output from the candidate programs from an expected output corresponding to an input associated with one or more fitness function(s) 124. Ranking module 116 may calculate and assign each candidate program a fitness score that measures an ability of a respective program in the parent population to produce output that matches an expected output based on a provided input associated with one or more fitness function(s) 124 (e.g., able to solve a targeted problem). The fitness of a candidate program may be measured in different ways, including, for example, in terms of the amount of error between its output and the desired output, the amount of resources (e.g., time, computing processing) required to achieve a desired target state, the accuracy of the candidate program, or compliance of the candidate program with user-specified criteria. Fitness scores of the candidate programs may be stored to genome dataset(s) cache 112.

Success analyzer 118 may determine whether a termination condition has been satisfied, such as whether one or more candidate programs of the population exhibit a high enough fitness score and sufficient for solving the targeted problem. If the termination condition has been satisfied, one or more candidate programs from the population may be stored to program storage 126. If the termination condition has not been satisfied (e.g., there are no candidate programs in the population that can sufficiently solve the targeted problem), genome control unit 120 may select one or more candidate programs and save them into a breeding pool. For example, candidate programs that perform well may be saved as parent candidate programs to produce better children candidate programs.

In particular, genome control unit 120 may instruct population generation module 110 to create a new generation of candidate programs that may better solve the targeted problem by evolving or breeding candidate programs from the previous generation. Genome control unit 120 may select candidate programs as parents for creating a next generation population of candidate programs according to their fitness score, e.g., relatively fit programs. Candidate programs with higher fitness scores may be more likely to be selected as parents than candidate programs with lower scores. However, a candidate program with the highest fitness score may not be guaranteed to be selected while candidate programs with low fitness scores may still be selected to a certain degree as parents and may not necessarily be discarded. It is noted that candidate programs for each generation may be retained in genome dataset(s) cache 112 for enabling look back operations which is further described below.

Genome control unit 120 may instruct population generation module 110 to breed or evolve the selected candidate programs by applying genetic operators to the selected candidate programs. The genetic operators may include reproduction, crossover, and mutation. Reproduction may comprise copying one or more selected candidate programs to the new population for a next generation. Crossover may comprise creating new offspring program(s) for the new population by recombining randomly chosen parts from two selected candidate programs (parents). Mutation may comprise creating a new offspring program for the new population by randomly mutating a randomly chosen part of a selected candidate program or by substitution of some random part of the selected candidate program with some other random part of the selected candidate program.

The aforementioned steps of testing, ranking/scoring, selecting, and breeding may be recursively repeated until success analyzer 118 determines that the termination condition is satisfied, thereby creating one or more solution programs that are suitable to solve the targeted problem.

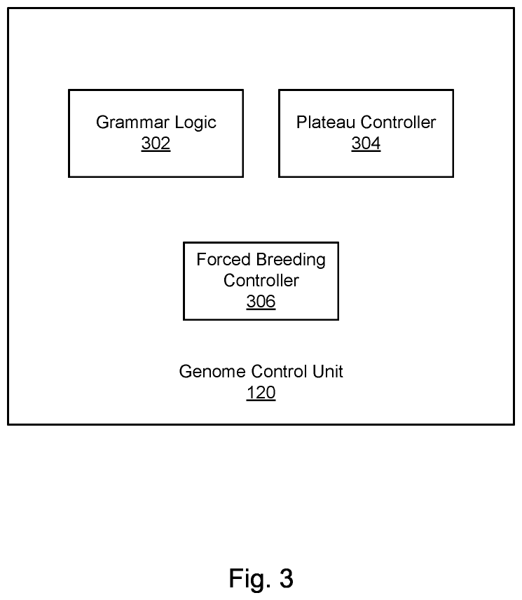

FIG. 3 presents components of a genome control unit according to an embodiment of the present invention. Genome control unit 120 includes a grammar logic 302, a plateau controller 304, and a forced breeding controller 306. The grammar logic 302 comprises instructions for defining structure and construct of programs generated by program generation unit 108. Grammar logic 302 may generally define a search space, i.e., the universe of possible candidate programs that may be generated. Population generation module 110 may create programs characterized by some degree of randomness which may be governed by grammar logic 302 defining a set of grammar rules. In particular, grammar logic 302 may specify programming structure and elements allowed for programs, such as expressions, variables, numbers, and keywords or statements, based on some predefined or dynamically adjusted statistical probability to construct valid candidate programs.

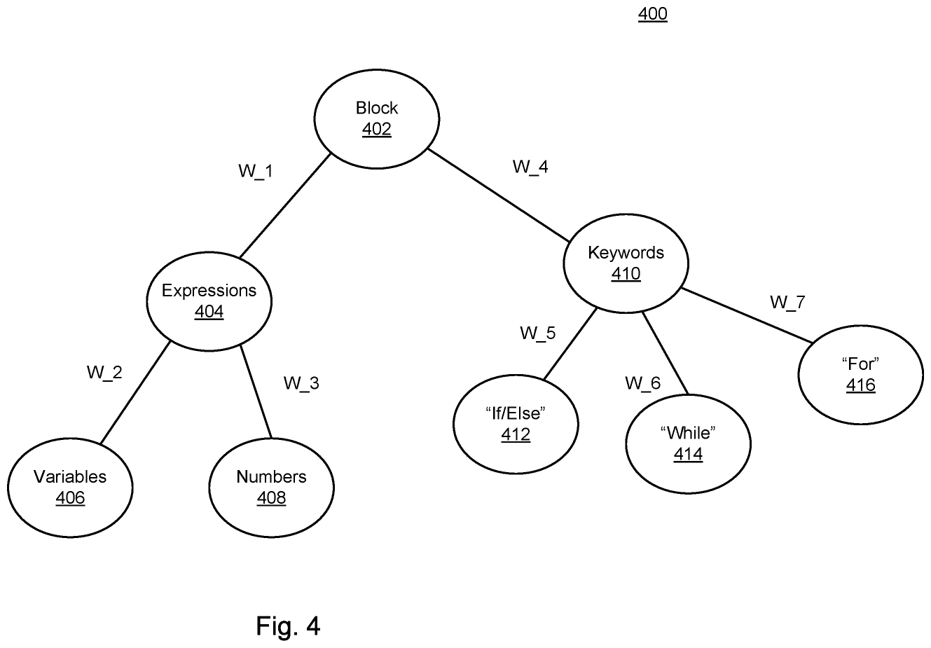

A candidate program may be generated in accordance with a set of rules, productions, and associated probabilities such as set forth in FIG. 4 by traversing nodes of grammar 400 in a stepwise fashion. Grammar 400 may guide population generation module 110 to prevent it from creating programs that are uniformly random. Population generation module 110 may be instructed by genome control unit 120 to follow a grammar structure provided by grammar logic 302 such as grammar 400. Grammar 400 includes block 402 comprising a structure of source code including expressions 404 and keywords 410. Expressions 404 include variables 406 and numbers 408 while keywords 410 include “If/Else” statements 412, “While” loops 414, and “For” loops 416.

The grammar 400 may specify the architecture for candidate programs based on weighted probabilities. For example, block 402 may be assigned a weighted probability W_1 of having expressions 404 that is higher than a weighted probability W_4 of having keywords 410. That is, expressions may have a higher occurrence in a block of code than keywords. Weighted probabilities of nodes at further depths, such as W_2 and W_3 corresponding to variables 406 and numbers 408, respectively, may be higher than W_1. Similarly, weighted probabilities of W_5, W_6, and W_7 corresponding to “If/Else” 412, “While” 414, and “For” 416 may be higher than W_4. The weighted probabilities may be assigned based on statistical analysis of sample programs and their attributes or on the basis of trial and error.

According to one embodiment, grammar logic 302 may specify a specific set of rules that is described by a context-free grammar, such as Backus-Naur Form (“BNF”) grammar. Context-free grammars can be used to express the syntax of most currently used programming languages. Various other formats, structures, syntaxes, and representation styles for grammars may also be employed. The present disclosure is not intended to be limited by any specific grammar syntax or by the particular format in which the grammars may be expressed. Grammar logic 302 may store and provide grammars that allow the creation of programs that are not limited to any particular system or domain regardless of a problem intended to be solved.

Referring back to FIG. 3, plateau controller 304 may be configured to determine how much advancement has been made by each generation of candidate programs towards fitness. Upon success analyzer 118 determining that a termination condition has not been satisfied, plateau controller 304 may compare output and performance of candidate programs from a current generation with output and performance of candidate programs from one or more previous generations to determine whether fitness progress made by candidate programs from the current generation has plateaued. Candidate programs from previous generations may be retained in genome dataset(s) cache 112 to enable look back operations by plateau controller 304.

Plateau controller 304 may determine that a current generation of candidate programs can no longer progress towards improved fitness or is at a point of diminishing returns. At that point, plateau controller 304 may cause an extinction of the current generation of candidate programs and create a new breeding pool for population generation. Plateau controller 304 may then load candidate programs from a prior generation and select given ones of the loaded candidate programs that have not been previously selected for breeding which may be inserted into the newly created breeding pool. The new breeding pool may seed breeding and creation of a new population and continue the aforementioned steps of testing, ranking/scoring, selecting, and breeding in recursive manner until a solution programs has been found or extinction resulting from another plateau condition. As such, plateau controller 304 facilitates searching of a different evolutionary path of candidate programs to find programs exceeding previous generational plateaus.

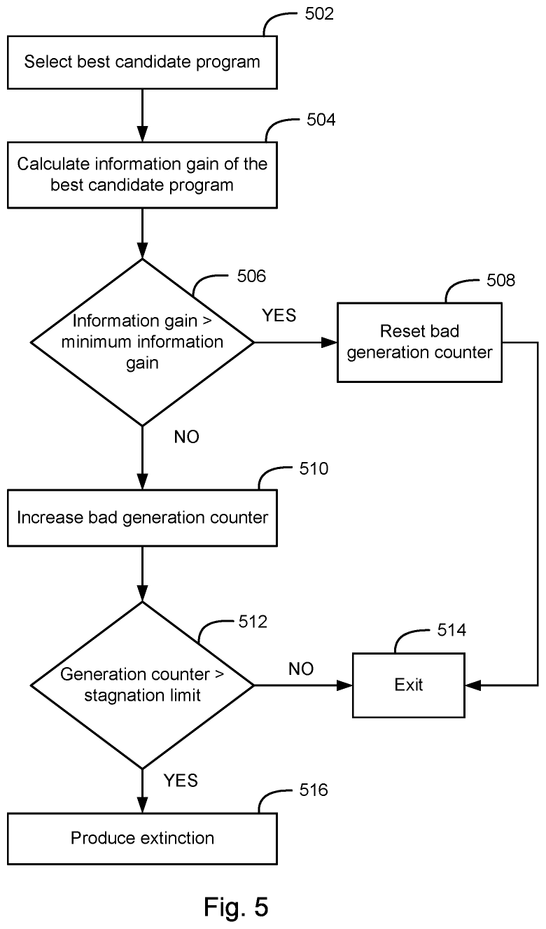

FIG. 5 presents a flowchart of a method for managing program population extinctions by an artificial intelligence computing system according to an embodiment of the present invention. A program population extinction routine may be initiated for each generation of candidate programs. The plateau controller 304 selects a best candidate program from a current generation, step 502. The best candidate program may be a candidate program having a highest fitness score among the current generation of candidate programs (e.g., determined by ranking module 116).

Information gain of the best candidate program with respect to one or more fitness functions is calculated, step 504. The information gain may comprise a measurement of gain of the best candidate program's fitness in the context of a target fitness. Information gain may be calculated by comparing data variance of output from best candidate programs from one or more previous generations with output from the best candidate program from the current generation. The information gain of the candidate programs with respect to one or more fitness functions may be used as a predictor of progress. Further description and details of information gain may be found in “A Mathematical Theory of Communication” by Claude Shannon, which is hereby incorporated by reference in its entirety.

The plateau controller 304 may determine whether the information gain is greater than a minimum information gain parameter, step 506. If the information gain is not greater than the minimum information gain, a bad generation counter is increased, step 510. The bad generation counter may comprise a count representative of a number of program generations that have not produced sufficient fitness progress. The bad generation counter may allow a window of generations to produce a best candidate program that exceeds the minimum information gain. A best candidate program producing information gain greater than the minimum information gain resets the bad generation counter, step 508, and proceeds to exit the program population extinction routine, step 514.

The program population extinction routine determines whether the generation counter exceeds a stagnation limit parameter, step 512. If the generation counter does not exceed the stagnation limit parameter, the program population extinction routine is exited, step 514.

However, once the generation counter exceeds a stagnation limit parameter (step 512), the plateau controller 304 produces extinction of the current population of programs. The stagnation limit parameter may be representative of a threshold number of program generations that have not progressed sufficiently, and thus the current breeding pool of candidate programs has reached a plateau in producing programs with improved fitness. Plateau controller 304 may allow a predetermined amount of generations without significant fitness progress (based on information gain) before extinction. Producing extinction may include purging the current population and breeding pool, selecting desirable candidate programs from one or more previous generations that were not previously selected for breeding, and creating a new generation.

Referring back to FIG. 3 forced breeding controller 306 may be configured to select candidate programs from a plurality of population generations for breeding. In particular, forced breeding controller 306 may select candidate programs with desired characteristics from each generation (e.g., with highest fitness score) and create a breeding pool of such candidate programs. Forced breeding controller 306 may execute a forced breeding routine for each generation of candidate programs to address or alleviate plateaus in program fitness progress. The forced breeding routine may be performed after determining that plateaus cannot be resolved by the program population extinctions discussed above. Alternatively, forced breeding may be executed simultaneously with program population extinctions.

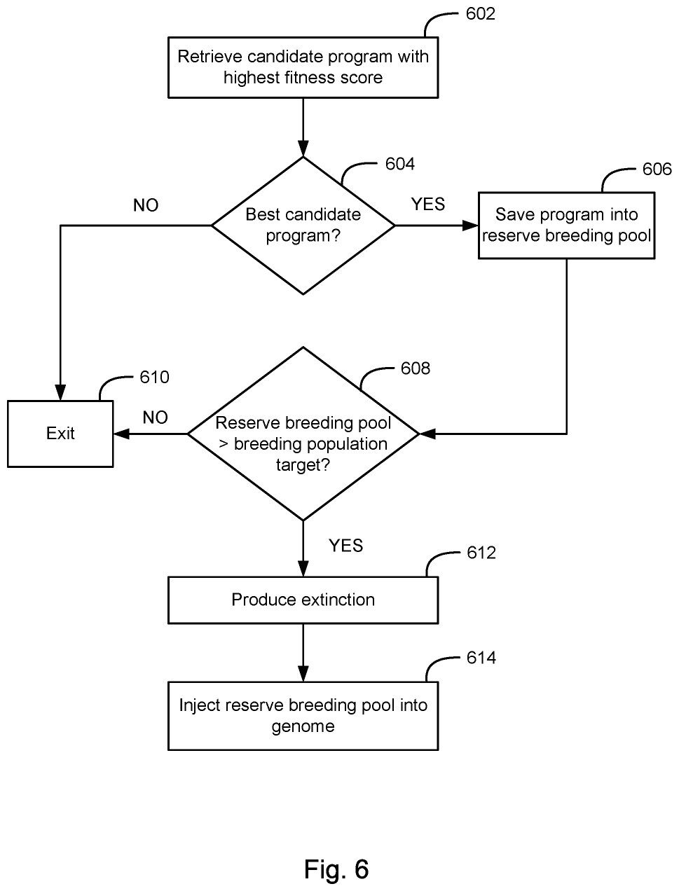

FIG. 6 presents a flow chart of a method for breeding candidate programs with desired characteristics by an artificial intelligence computing system according to an embodiment of the present invention. A forced breeding routine is executed for a current generation. The forced breeding controller 306 retrieves a candidate program with the highest fitness score from the current generation, step 602. The candidate program may be retrieved based on testing and ranking/scoring performed by, e.g., genome testing module 114 and ranking module 116.

The forced breeding controller 306 determines whether the candidate program is a best overall candidate program that has been produced through all cumulative generations. If the candidate program is not the best overall candidate program, the forced breeding routine is exited, step 610.

If the candidate program is the best overall candidate program, it may be set aside and saved into a reserve breeding pool, step 606. The reserve breeding pool may comprise a collection of best candidate programs from a plurality of program generations that are stored in memory for future breeding. The candidate program may also be checked if it exceeds a selection threshold based on a minimum fitness score as a requirement for saving into the reserve breeding pool.

The forced breeding routine determines whether the reserve breeding pool is greater than a breeding population target, step 608. If not, the forced breeding routine is exited, step 610. If the reserve breeding pool is greater than a breeding population target, an extinction is produced of the current population of programs, step 612. Characteristics of candidate programs in the reserve breeding pool are injected into a genome of programs that are used to create a new population, step 614. As such, features of the best candidate programs from cumulative generations are aggregated into a new population for solution searching and creating new candidate programs.

FIGS. 1 through 6 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps). In software implementations, computer software (e.g., programs or other instructions) and/or data is stored on a machine-readable medium as part of a computer program product and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the invention as described herein. In this document, the terms “machine readable medium,” “computer-readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. A system for generating programs to generate solution programs for solving a targeted problem, the system comprising:
a population generation module that generates a first population of candidate programs based on at least one of existing solution programs or knowledge data, the existing solution programs or knowledge data associated with the targeted problem;
a genome control unit configured to select one or more of the candidate programs from the first population and instruct the population generation module to apply at least one genetic operator to the selected candidate programs to create a second population of candidate programs;
a ranking module that calculates and assigns fitness scores to the candidate programs of the first and second populations;
a success analyzer that determines whether or not a terminating condition has been satisfied based on fitness scores of the candidate programs of the first and second populations; and
a plateau controller configured to determine plateauing of program fitness progress based on at least the fitness scores of the candidate programs of the first and second populations, delete the second population of candidate programs based on the determined plateauing, and generate a third population of candidate programs.

2. The system of claim 1 wherein the plateau controller is further configured to determine plateauing of program fitness progress by calculating information gain of a best candidate program from the second population with respect to a fitness function.

3. The system of claim 2 wherein the plateau controller is further configured to calculate the information gain by comparing output and performance of candidate programs from the second population with output and performance of candidate programs from the first population.

4. The system of claim 2 wherein the plateau controller is further configured to increase a bad generation counter if the information gain is less than a minimum information gain.

5. The system of claim 4 wherein the plateau controller is further configured to delete the second population of candidate programs based on the bad generation counter exceeding a stagnation limit parameter.

6. The system of claim 1 wherein the plateau controller is further configured to:
load candidate programs from the first population,
select given ones of the loaded candidate programs that have not been previously selected, and
apply the at least one genetic operator to the selected given ones of the loaded candidate programs.

7. The system of claim 1 wherein the genome control unit further comprises a grammar logic comprising instructions defining structure and construct of programs generated by the population generation module.

8. The system of claim 7 wherein the grammar logic is configured to specify programming structure and elements allowed for programs generated by the population generation module based on either a predefined or dynamically adjusted statistical probability.

9. The system of claim 7 wherein the grammar logic includes a grammar specifying an architecture for candidate programs based on weighted probabilities.

10. The system of claim 7 wherein the weighted probabilities are assigned based on statistical analysis of program attributes or on the basis of trial and error.

11. The system of claim 7 wherein the grammar logic is configured to specify a set of rules that is described by Backus-Naur Form grammar.

12. The system of claim 1 wherein the genome control unit further comprises a forced breeding controller configured to select best candidate programs from the first and second populations; and
create a reserve breeding pool with the selected best candidate programs.

13. The system of claim 12 wherein the forced breeding controller is further configured to inject characteristics of the selected best candidate programs from the reserve breeding pool into a genome of programs; and
create a new population using the genome of programs.

14. A method, in a data processing system comprising a processor and a memory, for generating programs to generate solution programs for solving a targeted problem, the method comprising:
generating a first population of candidate programs based on at least one of existing solution programs or knowledge data, the existing solution programs or knowledge data associated with the targeted problem;
calculating and assigning fitness scores to the candidate programs of the first population;
determining whether or not a terminating condition has been satisfied based on the fitness scores;
selecting one or more of the candidate programs from the first population based on the fitness scores;
applying at least one genetic operator to the selected candidate programs to create a second population of candidate programs;
calculating and assigning fitness scores to the candidate programs of the second population;
determining whether or not a terminating condition has been satisfied based on the fitness scores of the candidate programs of the first and second populations;
determining plateauing of program fitness progress based on at least the fitness scores of the candidate programs of the first population and the second population;
deleting the second population of candidate programs based on the determined plateauing; and
generating a third population of candidate programs.

15. The method of claim 14 further comprising determining plateauing of program fitness progress by calculating information gain of a best candidate program from the second population with respect to a fitness function.

16. The method of claim 14 further comprising:
loading candidate programs from the first population;
selecting given ones of the loaded candidate programs that have not been previously selected for breeding; and
inserting the selected given ones of the loaded candidate programs into the new breeding pool.

17. The method of claim 14 further comprising generating the first and second populations of candidate programs based on a grammar specifying an architecture for candidate programs based on weighted probabilities.

18. The method of claim 14 further comprising:
selecting best candidate programs from the first and second populations; and
creating a reserve breeding pool with the selected best candidate programs.

19. The method of claim 14 further comprising:
injecting characteristics of the selected best candidate programs from the reserve breeding pool into a genome of programs; and
creating a new population using the genome of programs.

20. A method, in a data processing system comprising a processor and a memory, for generating programs to generate solution programs for solving a targeted problem, the method comprising:
generating a first population of candidate programs based on at least one of existing solution programs or knowledge data, the existing solution programs or knowledge data associated with the targeted problem;
applying at least one genetic operator to given ones of the candidate programs from the first population to create a second population of candidate programs;
calculating and assigning fitness scores to the candidate programs from the second population;
determining plateauing of program fitness progress by calculating information gain of a best candidate program from the second population with respect to a fitness function, the information gain based on a comparison of output and performance of candidate programs from the second population with output and performance of candidate programs from the first population;
increasing a bad generation counter based on the information gain being less than a minimum information gain; and
deleting the second population of candidate programs based on the bad generation counter exceeding a stagnation limit parameter.
